(19) United States
(12) Patent Application Publication
(10) Pub. No.: US 2014/0337058 A1
(43) Pub. Date: Nov. 13, 2014

(54) System and Method for Healthcare Organization, Assistance, Communication, and Administration

(71) Applicants: John Sullivan, Webster, TX (US); Mary Ladmirault-Sullivan, Webster, TX (US)

(72) Inventors: John Sullivan, Webster, TX (US); Mary Ladmirault-Sullivan, Webster, TX (US)

(21) Appl. No.: 13/892,114

(22) Filed: May 10, 2013

(51) Int. Cl. G06Q 40/00

(52) U.S. Cl. CPC G06Q 40/08
USPC 705/4

(57) ABSTRACT

The present application is directed to a method and system for providing an insured's health insurance policy information to whom it may concern as desired by accessing an internet data base program to locate the insured's policy information and using the information to determine policy coverage for the insured according to the type of services to be rendered, fees associated there with, and the type of insurance policy held by the insured.

### CROSS-REFERENCE TO RELATED APPLICATIONS

The application is entitled to the benefit of the filing date of the prior-filed provisional application No. 61/645,251, filed on May 10, 2012.

### STATEMENT REGARDING FEDERALLY SPONSORED RESEARCH OR DEVELOPMENT

Not applicable.

### FIELD OF THE APPLICATION

The application relates generally to a system and method for organizing and/or administering and/or communicating healthcare related information.

### SUMMARY

The present application is directed to a method for providing an insured's health insurance policy information in real time comprising (1) compiling an insured's health insurance policy information to computer hardware coupled to computer readable memory featuring an internet-accessible data base program; (2) accessing the data base program via an internet ready electronic device at a desired time and location to obtain the insured's policy information on the data base program to attain information there from.

The present application is also directed to a method of maximizing healthcare insurance policy coverage for healthcare related services of an insured at the time of service, the healthcare insurance policy including two or more carriers, the method comprising: (1) a purchaser purchasing healthcare insurance for an individual insured including a primary health insurance policy from a first carrier and at least one gap health insurance policy from a second carrier, said insurance policies including a network of healthcare service providers; (2) the purchaser providing the insured's health insurance policy information to a third party for compiling the policy information to computer hardware coupled to computer readable memory featuring an internet-accessible data base program, the data base program being operationally configured to provide insurance related searchable information concerning one or more insureds; (3) providing the insured with access to the third party's internet-accessible data base program via an internet ready electronic device operationally configured to access information on the data base program; (4) at the time healthcare related services are to be rendered to an insured including services to be performed by at least one network healthcare service provider and at least one non-network healthcare service provider, accessing the data base program via the internet ready electronic device to locate the insured's policy information in the data base program including primary health insurance policy information and gap health insurance policy information; (5) using a calculation application accessible via the internet ready electronic device to determine the maximum dollar amount to be paid for the healthcare services under the primary health insurance policy and the maximum dollar amount to be paid under the gap health insurance policy; and (6) applying the total healthcare policy coverage dollar amounts to the service fee minus any applicable copay amounts calculated.

The present application is also directed to a system for assisting an insured with obviating out-of-pocket expenses at the time one or more services are to be rendered by a healthcare provider comprising: (1) computer hardware coupled to computer readable memory featuring an internet-accessible data base program, the data base program being operationally configured to store and process health insurance policy information accessible by one or more Human Resources departments, benefit plan administrators, healthcare practitioners, insurance carriers, healthcare providers, employers, insureds, dependents, and combinations thereof; and (2) one or more internet ready electronic devices operationally configured to communicate with the internet-accessible data base program; wherein the data base program includes program code operationally configured to determine the fee payable for the services being rendered under the insured's insurance policy according to one or more of the service fee, an insured's policy information in the data base program including primary health insurance policy information and gap health insurance policy information and the insured's copay requirements.

### BACKGROUND

Healthcare is an industry wherein time and money are often consumed procuring and delivering healthcare information to persons and groups. Whether via preferred provider arrangements, capitation arrangements, case management, etc., determining the type of healthcare to be allowed, the services that will be paid for and by whom, and making sure that the appropriate information is provided to the appropriate party can consume both time and financial resources of insurance carriers, healthcare service providers, employers, patients and healthcare recipients.

Even with the connectivity the internet provides, information exchange between carriers, providers, employers, patients and healthcare recipients and insureds is lacking. Most of the information available to patients from their carriers is drawn from databases related to either general healthcare literature or to specific normality support groups. A critical aspect of a person's healthcare program, however, is not only knowledge of the normality or support groups, but also what his/her carrier's healthcare plan provides as treatment options for that normality, eligibility information, referral authorization, claim submission and payment, testing, and medications. Personally-referenced information linked to an individual's provider and healthcare plan is generally unavailable, requiring human intervention to extract and process the data.

Recent healthcare reform in the United States has adversely affected rates charged by major medical health insurance carriers. This has created a need for a new method of providing healthcare coverage that involves several “layers” of coverage provided by multiple carriers to achieve the level of coverage employees are accustom to having at rates the employers and employees can afford to sustain. This reform will require longer more involved orientation and consulting as healthcare recipients actually use the plans.

It is desirable to provide carriers, providers, employers, insureds, patients and healthcare recipients an effective, efficient tool to introduce and manage new multi-layered health insurance plans being offered in a cost-effective manner thereby reducing the administrative burden and providing technology to streamline communication between carriers, providers, employers, patients and healthcare recipients.

### BRIEF DESCRIPTION OF THE FIGURES

FIG. 1 is a diagram of an embodiment of the present system.

FIG. 2 is an exemplary website page of an embodiment of the present system.

FIG. 3 is a flowchart representative of an embodiment of the present system.

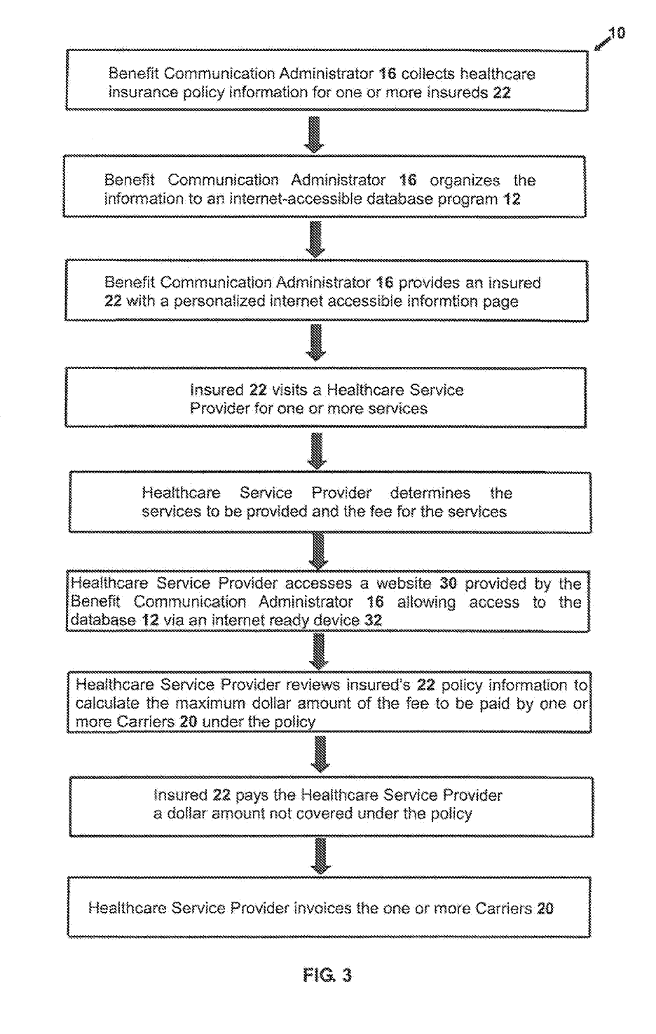

FIG. 4 is a flowchart representative of an embodiment of the present system.

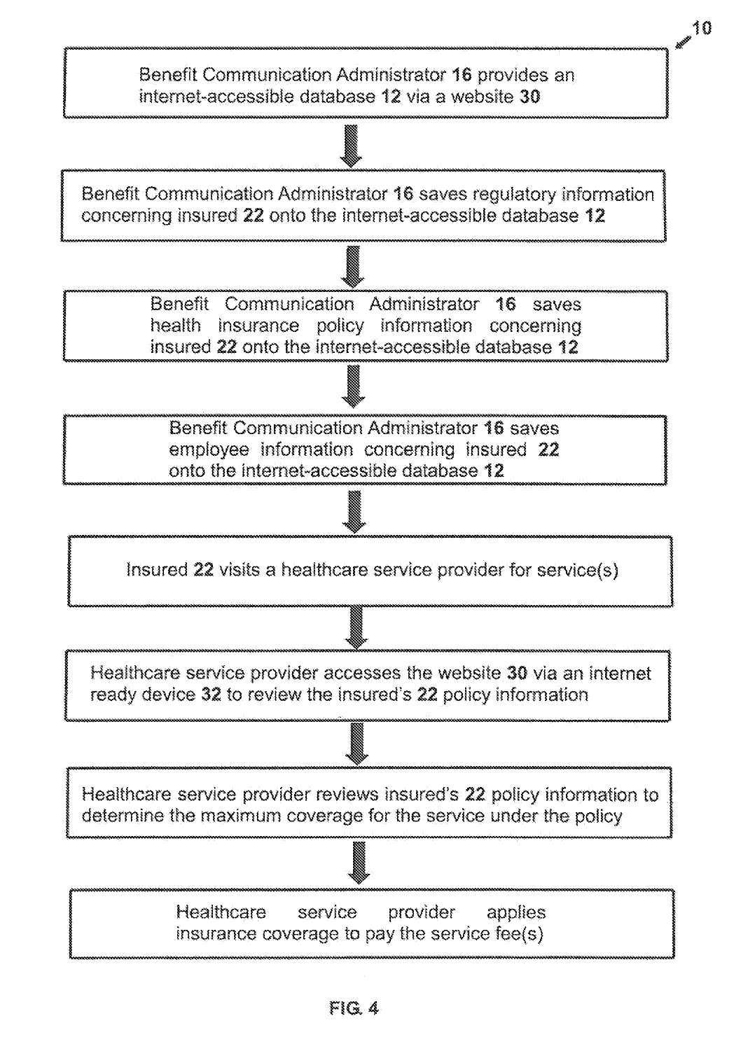

FIG. 5 is a flowchart representative of an embodiment of the present system.

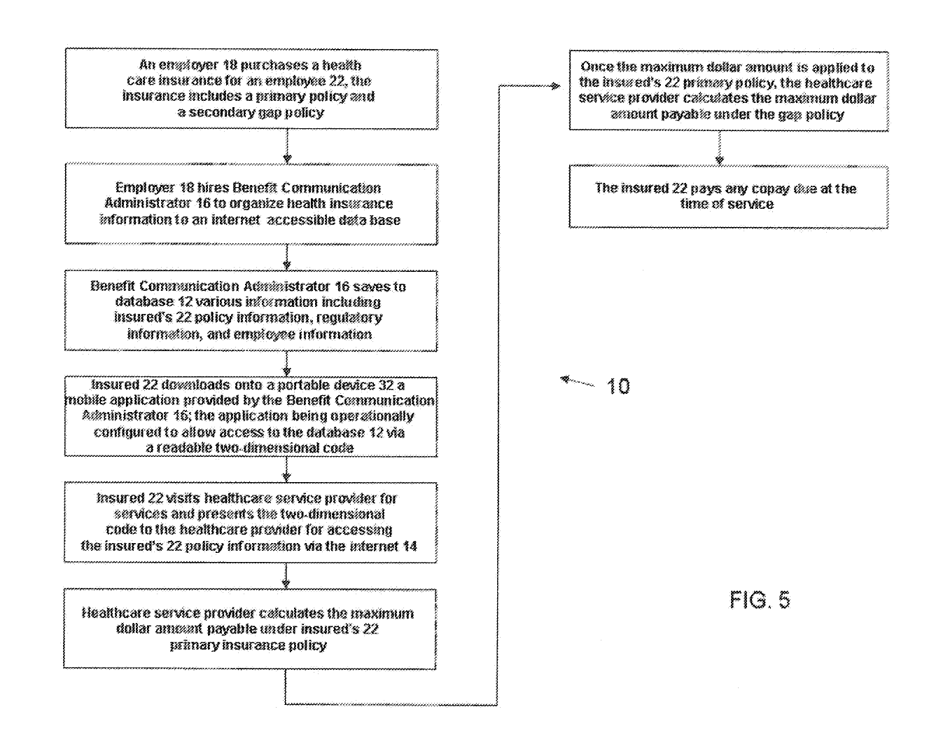

FIG. 6 is a flowchart representative of an embodiment of the present system.

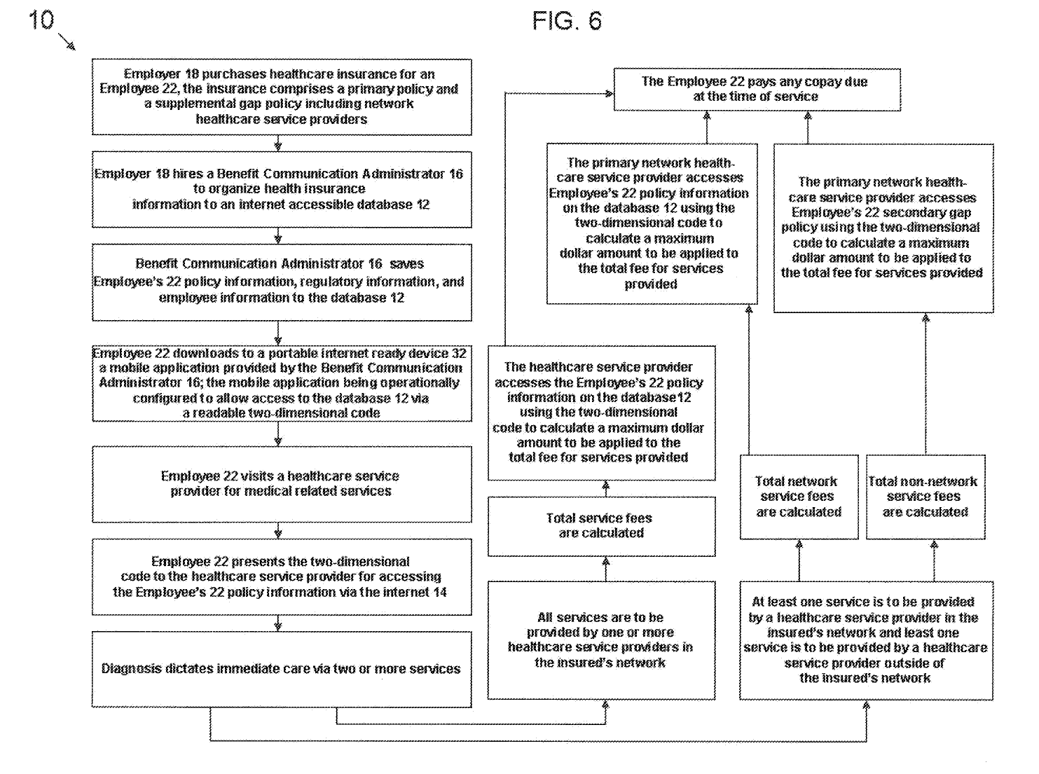

### BRIEF DESCRIPTION

It has been discovered that a system and method may be provided that allows employers, insureds, and healthcare service providers access to carrier and policy information for an insured via an internet accessible database, including at the time of service, the system and method being effective to assist with the conveyance and/or understanding of policy information. Heretofore, such a desirable achievement has not been considered possible, and accordingly, the system and method of this application measure up to the dignity of patentability and therefore represents a patentable concept.

Before describing the invention in detail, it is to be understood that the present system and method are not limited to particular embodiments. It is also to be understood that the terminology used herein is for the purpose of describing particular embodiments only, and is not intended to be limiting. As used in this specification and the appended claims, the phrase “health insurance” means insurance against loss by illness or bodily injury and provides coverage for medicine, visits to the doctor or emergency room, hospital stays and other medical expenses. The term “insured” refers to an individual for which an insurance policy is issued, including family members and dependents as the terms are known by persons of ordinary skill in the art. The term “deductible” refers to the amount that the insured must pay out-of-pocket before the health insurer pays its share. The terms “coinsurance” and “copayment,” “copay” and like terms may be used interchangeably to refer to money that an insured is required to pay for services, after a deductible has been paid. “Provider” is a term used for health professionals who provide healthcare services, also referred to herein as “healthcare service providers.” The “time of service” refers to the actual time in which an insured is receiving one or more services from a healthcare service provider including pre-treatment and post-treatment. For the purpose of this application, the term “carrier” may be interchanged with the terms “insurer” and “payor.” Such terms include health insurance companies, but also may include health maintenance organizations, self-insured entities, disease management organizations, capitated healthcare providers, Medicare agencies, as well as any other organization that might store or manage healthcare data. In one aspect, the term “healthcare” may refer to services offered by the health profession including, but not necessarily limited to Doctors of Medicine, Doctors of Osteopathic Medicine, Doctors of Dental Medicine, Doctors of Chiropractic, Doctors of Chinese Medicine, psychologists, hypnotherapists, dieticians, massage therapists, family counselors, optometrists, and combinations thereof, all of which may referred to as “healthcare service providers.” In another aspect, the term “healthcare” may refer to supplies and/or equipment including but not necessarily limited to medications (prescription and non-prescription), medical devices, health products, beauty products, prosthetics, disposable supplies, mobility aids, eyewear, and combinations thereof. The term “smart phone” means a mobile telephone with an integrated computer and other features not originally associated with telephones, such as an operating system, web browsing and the ability to run software applications. The phrase “health insurance exchange” (“H.I.E.”) may refer to one or more of the following: (1) a tool for organizing a private insurance marketplace for a relatively narrow group of individuals receiving subsidized insurance; (2) a mechanism for offering anyone a choice of a public or private insurance plan, and providing oversight of insurers beyond current insurance regulations. An individual purchasing insurance through a health insurance exchange may be able to choose healthcare coverage that is best for him/her and their family. Healthcare plans to be offered through a health insurance exchange may include an essential set of benefits that provide comprehensive healthcare services with different levels of cost sharing. Also, annual out-of-pocket expenses (deductibles, copayments, and coinsurance) may be limited to an amount equal to the Health Savings Account (HSA) current law limit.

More particularly, the United States Patient Protection and Affordable Care Act (Public Law 111-148)) signed into law in March 2010 by President Barack Obama, provides that beginning on Jan. 1, 2014 health insurance exchanges will be created where an individual or small business can compare the costs of various health plans and different types of health coverage benefits. If a particular U.S. state decides not to operate its own health insurance exchange, an individual will be able to purchase a health plan from a multi-state, or regional exchange run by a government agency (such as the federal Department of Health and Human Services) or a non-profit organization. According to the health reform bill, only U.S. citizens and legal immigrants who are not imprisoned will be eligible to purchase a health plan in one of the exchanges, and small businesses with up to 100 employees can purchase health coverage for their employees in an exchange. Beginning in year 2017, the states may allow businesses with more than 100 employees to purchase coverage in an exchange. Each health insurance exchange must offer at least two health plans that are available in two or more states. At least one of these health plans must be a non-profit organization and each plan must be licensed in each state. Enrollment in one of these plans will provide individuals access to healthcare services in different states fostering competition to lower premiums. The health reform bill will also provide loans and grants to create non-profit, member-run health insurance companies known as Consumer Operated and Oriented Plans (CO-OPs). To be eligible to receive federal funds, an organization wanting to set up a CO-OP must meet the following requirements: (1) not be an existing health insurer or sponsored by a state or local government; (2) its activities must only consist of the providing and managing health benefit plans in each state in which it is licensed; (3) control of the organization must be subject to a majority vote of its members; (4) must operate with a strong consumer focus; (5) all profits must be used to lower premiums, improve benefits, or improve the quality of healthcare delivered to its members.

In one aspect, the present application provides employer's employees immediate and easy access to all aspects of their healthcare benefit plan by logging on to a website including a password protected website that gives the employee and/or his/her dependents one or more of the following: policy information, plan outlines, claims information, provider network information, health insurance exchange information, orientation, discounts, 401k information, as well as support for plan administrators including healthcare reform reporting, legal updates and billing information. The website may be made available in any desired language or languages. The website may also provide workers' compensation information regarding subscribers and non-subscribers plans including instructions for employers when an accident to an employee occurs.

In another aspect, the application provides a method for providing employers and employees access to all carrier and policy information including but not necessarily limited to policy numbers, plan benefit summaries, major medical insurance plans, 401K information, critical illness information, major medical gap coverage insurance plan information, life insurance information, disability insurance information, accident related information, dental related information, vision related information, pet insurance information, life lock information, pre-paid legal information, maternal coverage information, and combinations thereof.

In another aspect, the application provides immediate access to information on provider networks and emergency services using a one-dimensional barcode or two-dimensional code such as a quick response code (“QR barcode”) or tag via an internet ready device seven days a week, twenty four hours a day.

In another aspect, the application provides a compliance consulting service effective to allow human resource professionals (“HR” or “HR Department”) to access the latest regulatory updates, proper forms and deadline information and the reporting that is required by several federal agencies such as IRS, ERISA and the Department of Labor.

In another aspect, the application provides HR professionals and benefit plan administrators an effective, efficient tool to introduce and manage multi-layered plans.

In another aspect, the application frees up unlimited man hours for HR departments, benefit plan administrators, healthcare practitioners, insurance carriers, healthcare providers, employers, insureds, dependents, and combinations thereof.

In another aspect, the application provides an electronic system that may be offered via a subscription to one or more of the following: insurance professionals including brokers, agents, third party administrators, benefit communication administrators, general agencies and PEO (employee leasing companies and payroll services). The system may also to be sold to insurance companies and others to market to clients.

In another aspect, the application provides a benefit communication administrator for creating and maintaining a unique website for an employer and/or individuals for one or more fees including but not necessarily limited to setup fees, annual fees, monthly fees, and combinations thereof.

In another aspect, the application provides an electronic system operationally configured to allow employers to electronically communicate company benefit information to the system's database.

In another aspect, the application may involve one or more brokers for procuring customers for the benefit communication administrator of the electronic system.

In another aspect, the application provides an internet accessible database secured via one or more passwords and usernames.

In another aspect, the application provides an internet accessible database including one or more of compliance manuals, safety manuals, customized employer/company access, provider networks, remote work direction, orientation and instructional videos including, but not necessarily limited to videos tailored for particular policies or integrated plans including directions on how to utilize plans.

In another aspect, the present system may comprise agreements with vendors to offer discount merchandise or memberships for the use and pleasure of users of the system including, for example, an employer's employees and other insureds.

In another aspect, the application provides a system including a method for a benefit plan administrator to enroll, unenroll, and manage Consolidated Omnibus Budget Reconciliation Act (COBRA) benefits using the internet accessible database.

In another aspect, the application provides an internet accessible database providing service price comparison information, e.g., the cost for Magnetic resonance imaging (MRI) at a particular hospital versus the cost for an MRI at a particular free standing health clinic.

In another aspect, the application provides internet and mobile access via smart phone access to insureds' insurance policy information (be it individual, group or health exchange, life, accident, or supplemental plans) including policy numbers, plan benefit summary, orientation and directions how to utilize integrated plans in one or more languages as well as enrollment and policy change abilities.

In another aspect, the present application includes a system and method that allows insureds or other consumers at their discretion, to use unique software to enter vital health history data to a secure application that can be transferred via encrypted electronic mail to healthcare providers and/or insurance carrier underwriters or claims departments.

In another aspect, the present application allows employers, professional employer organizations (PEO's), third party administrators (TPA's), health insurance marketing organizations (IMO's), health insurance brokers and agents and other entities to provide Human Resources department information to their employees, insureds and dependents including, but not necessarily limited to benefits plan information and enrollment ability, workers' compensation plan information, employee and safety manuals and various other pertinent information with twenty-four hour seven days a week internet access via computer or mobile devices in one or more languages.

In another aspect, the present application provides a method for determining an insured's health insurance coverage at the time of service comprising (1) compiling an insured's health insurance policy information to an internet-accessible data base; (2) at the time of a provider's service, determining the fee payable for the service being rendered; (3) accessing the data base via an internet ready device; (4) locating policy information within the data base; (5) analyzing the policy information in view of the type of service provided and the service fee to determine coverage of the service fee; and (6) paying a maximum amount of the fee using the insurance according to the policy information listed on the data base.

In another aspect, the present application provides a method for providing an insured with health insurance coverage information at the time of service comprising (1) receiving an insured's health insurance policy information; (2) compiling the policy information to an internet-accessible data base; (3) at the time of service, determining the fee payable for the service being rendered; (4) accessing the data base via an internet ready device; (5) locating the insured's policy information within the data base; (6) reviewing the policy information in view of the service being rendered to determine any applicable services fees to be covered by insurance; and (7) applying a maximum amount of the fee to the insured's insurance.

In another aspect, the present application provides a method for an insured to communicate health insurance policy information to a healthcare provider at the time of service comprising (1) providing health insurance policy information to a third party, said third party compiling the policy information to an internet-accessible data base; (2) at the time of service, determining the service being rendered; (3) accessing the data base via an internet ready device; (4) locating the insured's policy information within the data base; and (5) reviewing the policy information in view of the service being rendered to determine any insurance coverage for the service.

In another aspect, the present application provides a method of assisting an insured with obviating out-of-pocket expenses at the time of service from a healthcare provider comprising (1) providing an insured's health insurance policy information to a third party for compiling the policy information to an internet-accessible data base, the data base being operationally configured to provide subject searchable information; (2) providing the insured with a mobile internet ready device operationally configured to communicate with the internet-accessible data base; (3) at the time of service, determining the fee payable for the service being rendered; (4) accessing the data base via an internet ready device; (5) locating the insured's policy information within the data base; (6) reviewing the policy information in view of the service being rendered to determine any applicable services fees to be covered by insurance; and (7) applying a maximum amount of the fee to the insured's insurance.

In another aspect, the present application provides a method of communicating health insurance policy information comprising (1) providing an internet-accessible data base; (2) receiving from one or more regulatory bodies, for storing on the data base, regulatory information concerning an insured; (3) receiving from one or more carriers, for storing on the data base, health insurance policy information concerning an insured; (4) receiving from the purchaser of the health insurance, for storing on the data base, information concerning the insured; (5) organizing the information on the data base in a manner effective for the purchaser, carrier, and insured to communicate one or more types of information in a paperless and non-verbal manner effective for the insured's healthcare services to be provided according to the terms of the policy.

In another aspect, the present application provides a method of determining healthcare coverage of an insured, comprising (1) providing an internet-accessible data base; (2) receiving from one or more regulatory bodies, for storing on the data base, regulatory information concerning an insured; (3) receiving from one or more carriers, for storing on the data base, health insurance policy information concerning an insured; (4) receiving from the purchaser of the health insurance, for storing on the data base, information concerning the insured; (5) organizing the information on the data base in a manner effective to communicate one or more types of information in a paperless and non-verbal manner, said information being provided in at least two languages; (6) providing the insured with a mobile internet ready device operationally configured to communicate with the internet-accessible data base; (7) at the time of healthcare related service, determining the fee payable for the service being rendered; (8) accessing the data base via an internet ready device; (9) locating the insured's policy information within the data base; (10) reviewing an insured's primary health insurance policy information to calculate the maximum dollar amount to be paid for the service under the primary health insurance policy; (11) deducting the maximum primary dollar amount from the service fee; (12) locating any secondary health insurance policy information for the insured to calculate the maximum dollar amount to be paid for the service under the secondary health insurance policy; (13) deducting the maximum secondary dollar amount from the service fee; and (14) applying the healthcare policy coverage to the service fee minus any applicable copay amount.

In another aspect, the present application provides a method of determining healthcare coverage of an insured, comprising (1) a purchaser of healthcare providing an insured's health insurance policy information to a third party; (2) the third party compiling the policy information to an internet-accessible data base, the data base being operationally configured to provide insurance related searchable information, said information being provided in at least two languages; (3) providing the insured with a mobile internet ready device operationally configured to communicate with the internet-accessible data base, said device being operationally configured to generate a two-dimensional code for others to scan providing access to an insured's information; (4) at the time of service, determining the fee payable for the service being rendered; (5) providing the two-dimensional code to a healthcare service provider, the service provider scanning the two-dimensional code using a two-dimensional code reader to access the internet-accessible data base; (6) accessing the data base via an internet ready device; (7) locating the insured's policy information within the data base; (8) reviewing an insured's primary health insurance policy information to calculate the maximum dollar amount to be paid for the service under the primary health insurance policy; (9) deducting the maximum primary dollar amount from the service fee; (10) locating any secondary health insurance policy information for the insured to calculate the maximum dollar amount to be paid for the service under the secondary health insurance policy; (11) deducting the maximum secondary dollar amount from the service fee; and (12) applying the healthcare policy coverage to the service fee minus any applicable copay amount.

In another aspect, the present application provides a method of determining healthcare coverage of an insured, comprising (1) providing an internet-accessible data base; (2) receiving from one or more regulatory bodies, for storing on the data base, regulatory information concerning an insured; (3) receiving from one or more carriers, for storing on the data base, health insurance policy information concerning an insured; (4) receiving from the purchaser of the health insurance, for storing on the data base, information concerning the insured; (5) organizing the information on the data base in a manner effective to communicate one or more types of information in a paperless and non-verbal manner, said information being provided in at least two languages; (6) providing the insured with an internet address for locating the internet-accessible data base; (7) establishing security information to protect the insured's information located on the internet-accessible data base; (8) at the time of healthcare related service, determining the fee payable for the one or more services being rendered; (9) providing the healthcare service provider with the internet address and security information to access the insured's internet-accessible data base; (10) locating the insured's policy information within the data base; (11) reviewing an insured's primary health insurance policy information to calculate the maximum dollar amount to be paid for the service under the primary health insurance policy; (12) deducting the maximum primary dollar amount from the service fee; (13) locating any secondary health insurance policy information for the insured to calculate the maximum dollar amount to be paid for the service under the secondary health insurance policy; (14) deducting the maximum secondary dollar amount from the service fee; and (15) applying the healthcare policy coverage to the service fee minus any applicable copay amount.

In another aspect, the present application provides a method of determining healthcare coverage of an insured, comprising (1) a purchaser of healthcare providing an insured's health insurance policy information to a third party; (2) the third party compiling the policy information to an internet-accessible data base, the data base being operationally configured to provide policy related searchable information including one or more tutorials explaining the insured's health insurance coverage and how to apply the coverage to one or more particular services, said searchable information being provided in at least two languages; (3) providing the insured with a mobile internet ready device operationally configured to communicate with the internet-accessible data base, said device being operationally configured to generate a two-dimensional code for others to scan; (4) at the time of service, determining the fee payable for the one or more services being rendered; (5) providing the two-dimensional code to a healthcare service provider, the service provider scanning the two-dimensional code using a two-dimensional code reader to access the internet-accessible data base; (6) accessing the data base via an internet ready device; (7) locating the insured's policy information within the data base; (8) using one or more tutorials to determine application of the insured's health insurance to calculate the maximum dollar amount to be paid for the one or more services; (9) deducting the maximum dollar amount from the service fee pursuant to information provided to the healthcare provider via the one or more tutorials; and (10) applying the healthcare policy coverage to the service fee minus any applicable copay amount.

In another aspect, the present application provides a method of determining healthcare coverage of an insured, comprising (1) a purchaser of healthcare providing an insured's health insurance policy information to a third party; (2) the third party compiling the policy information to an internet-accessible data base, the data base being operationally configured to provide policy related searchable information including one or more tutorials explaining the insured's health insurance coverage and how to apply the coverage to one or more particular services, said policy information being provided in at least two languages; (3) the third party compiling regulatory information concerning an insured to the internet-accessible data base; (4) providing the insured with an internet address for locating the internet-accessible data base; (5) establishing security information to protect the insured's information located on the internet-accessible data base; (6) at the time of healthcare related service, determining the fee payable for the one or more services being rendered; (7) providing the healthcare service provider with the internet address and security information to access the insured's internet-accessible data base; (8) locating the insured's policy information within the data base; (9) using one or more tutorials to determine application of the insured's health insurance to calculate the maximum dollar amount to be paid for the one or more services; (10) deducting the maximum dollar amount from the service fee pursuant to information provided to the healthcare provider via the one or more tutorials; and (11) applying the healthcare policy coverage to the service fee minus any applicable copay amount.

In another aspect, the present application provides a method of maximizing healthcare insurance coverage for healthcare related services of an insured at the time of service, said insurance being provided by two or more carriers comprising (1) a purchaser purchasing health insurance for an insured including a primary health insurance policy from a first carrier and at least one gap health insurance policy from a second carrier, said policies including a network of healthcare service providers; (2) the purchaser providing the insured's health insurance policy information to a third party; (3) the third party compiling the policy information to an internet-accessible data base, the data base being operationally configured to provide insurance related searchable information, said policy information being provided in at least two languages; (4) providing the insured with means for accessing the internet-accessible data base including (a) a mobile internet ready device operationally configured to communicate with the internet-accessible data base, said device being operationally configured to generate a two-dimensional code for others to scan, and (b) an internet address and security information to access the insured's internet-accessible data base; (5) at the time of healthcare related service, determining the fee payable for the one or more services being rendered, the services including at least one provider being part of said network and at least one provider being outside of said network; (6) providing the healthcare service provider with means for accessing the internet-accessible data base; (7) locating the insured's policy information within the data base; (8) reviewing the insured's primary health insurance policy information to calculate the maximum dollar amount to be paid for the service under the primary health insurance policy; (9) deducting the maximum primary policy dollar amount from the service fee; (10) reviewing the gap health insurance policy information for the insured to calculate the maximum dollar amount to be paid for the service provided by the provider outside of the network; (11) deducting the maximum gap policy dollar amount from the service fee; and (12) applying the total healthcare policy coverage to the service fee minus any applicable copay amount.

### DISCUSSION OF EMBODIMENTS

To better understand the novelty of the invention, reference is hereafter made to the accompanying drawings. In general, the invention involves collecting, storing, communicating, displaying, administering, and/or analyzing information regarding an insured and healthcare insurance policy coverage. In another aspect, the invention is directed to a method of enabling an insured to access all of his/her healthcare insurance benefit plans information via a portable computer, smart phone, notebook computer, internet ready device, or other electronic portable device using a unique website address and/or a barcode including, but not necessarily limited to a one-dimensional barcode, two-dimensional tag or QR barcode of a smart phone, internet ready device, or other electronic portable device effective to direct the insured and healthcare provider to a customized website that will allow secure access to all (1) health insurance policy benefit information of the insured, (2) orientation and instructional type information regarding benefits, (3) a forms library, (4) frequently asked questions (“FAQ's”), (5) discount offerings, (6) instant links to carrier network information and/or other benefits such as employer or company benefits and/or health insurance exchange information. This same customized website suitably enables an employer's human resources department and/or benefit plan administrator secure access to carriers and/or applicable health insurance exchanges to assist in managing billing, enrollment and disenrollment, compliance to new and changing laws regarding healthcare reform, COBRA administration, Workers' Compensation administration, and combinations thereof.

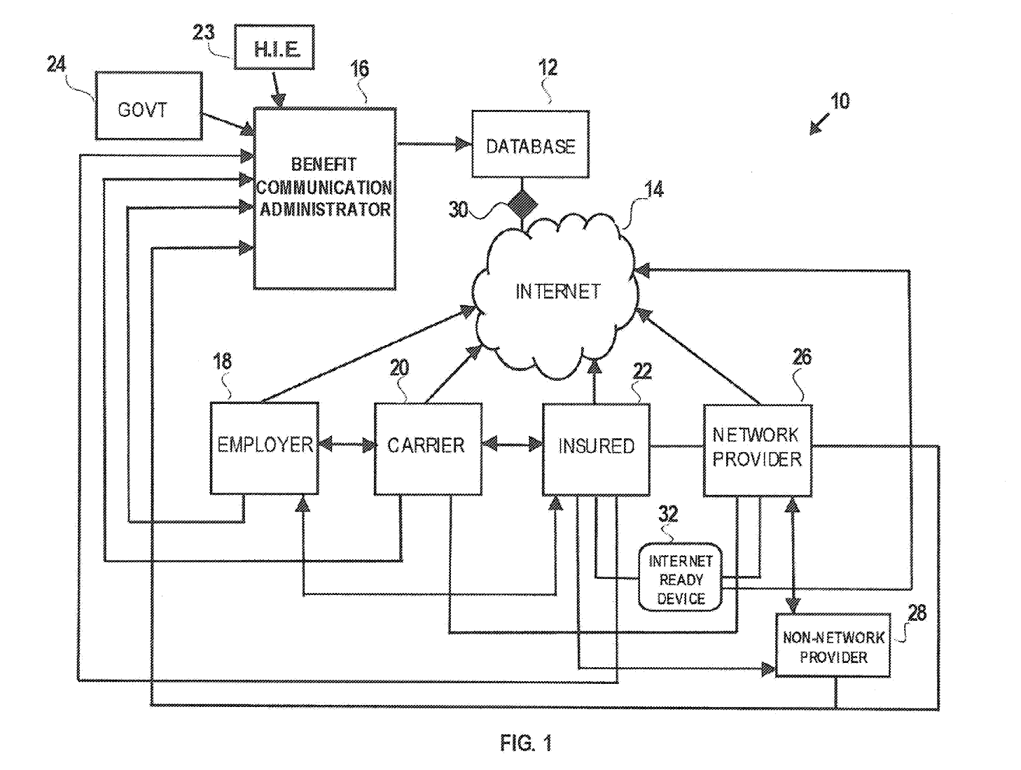

Reference will now be made in detail to embodiments, examples of which are illustrated in the accompanying drawings. In the following detailed description, numerous specific details are set forth in discussing the present invention. However, it will be apparent to one of ordinary skill in the art that the present invention may be practiced without various specific details. With reference now to a simplified illustration of the invention as provided in FIG. 1, a system 10 for collecting, storing, communicating, administering, displaying, and/or analyzing information regarding an insured and an insured's healthcare insurance policy coverage is provided, the system 10 including a computer database program 12 for storing and providing information over a communication network including, but not necessarily limited to the internet 14 although intranets and other networks are contemplated.

Although information to be stored on the computer database 12 may be collected as desired, in discussing the embodiment of FIG. 1, information is suitably collected and stored on a target computer database (hereafter “database”) 12 by a benefit communication administrator 16. As understood by the skilled artisan, the database 12 may be provided via computer hardware coupled to computer readable memory featuring program code including a database 12 operationally configured for internet accessibility as desired. As shown, the benefit communication administrator 16 collects or retrieves data and other information from one or more sources via electronic communication and/or hardcopies and/or verbal communication. For example, the benefit communication administrator 16 may collect and/or retrieve and/or receive benefits related information from an employer 18 or company providing healthcare insurance for one or more employees and dependants. The benefit communication administrator 16 may also collect and/or retrieve and/or receive policy related information from one or more insurance carriers 20. The benefit communication administrator 16 may also collect and/or retrieve and/or receive personal benefits related information from the insured 22, which in this embodiment includes an employee of the employer 18 and/or his/her dependents. The benefit communication administrator 16 may also collect and/or retrieve and/or receive policy related information and/or regulatory information from one or more health insurance exchanges 23 (“H.I.E”). The benefit communication administrator 16 may also collect and/or retrieve and/or receive regulatory information from one or more government regulatory bodies 24. The benefit communication administrator 16 may also collect and/or retrieve and/or receive electronic health record related information from one or more healthcare service providers including network providers 26 and non-network providers 28. Electronic health record information may include, for example, patient information (e.g., name, address, phone number, date of birth, social security number, etc.), medical information (e.g., medical facility information, notes—such as those entered by a doctor, test results, x-rays, prescribed medications, professional services provided, etc.), financial information (e.g., billing information, payment information, transaction history, etc.). The information may then be organized onto the computer database 12 as necessary. In a jurisdiction where health record information is maintained in confidence, a patient may volunteer the information to a benefit communication administrator 16.

The database 12 may include a single database or a collection of database programs herein defined as an integrated collection of data records, files, and other objects, the creation, maintenance, and use of which is controlled by a database management system (“DBMS”) or the like. In general, a DBMS may allow different user application programs to concurrently access the same database or databases. In one embodiment, the benefit communication administrator 16 may provide a unique website 30 for an employer, group or individual accessible over the internet 14 whereby one or more entities, groups or individuals, including but not necessarily limited to employers, insureds, carriers, and healthcare service providers 26, 28 may access information stored on the database 12.

Without limiting the invention, the benefit communication administrator 16 may include a for-profit entity, a not-for-profit entity, a health insurance exchange, or a governmental entity for administering the system 10. For example, in one embodiment the benefit communication administrator 16 may include an insurance advisement company in the business of selling customized individual and/or employer insurance products including a portfolio of primary and supplemental insurance policies. For example, the benefit communication administrator 16 may make available to an employer 18 at least a primary group health insurance plan for its employees or insureds 22. The benefit communication administrator 16 may also make available to an employer 18 one or more supplemental or gap plans for the employees as desired. Once one or more insurance related products have been sold to the employer 18, the benefit communication administrator 16 may collect policy related information voluntarily provided by the employer 18, personal medical (or non-medical via HIPAA) related information from each employee or insured 22 and policy related information from each of the insurance carriers 20 for organizing the information onto the database 12 in a manner effective for easy access via the website 30 by the employer 18 and/or insured 22.

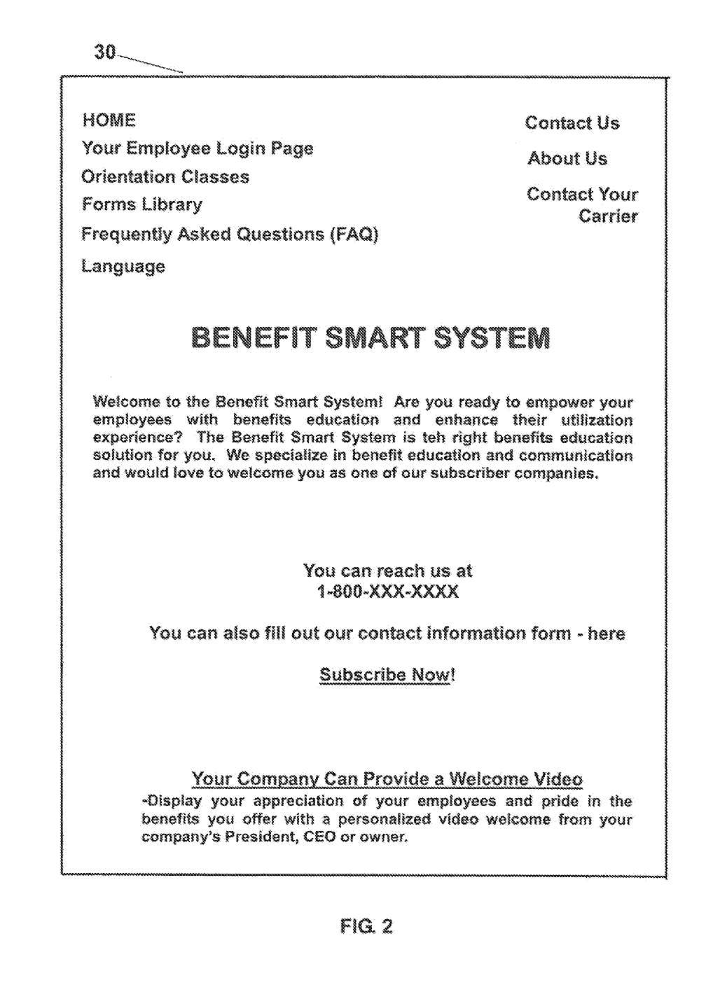

An exemplary website page 30 of the system 10 is provided in FIG. 2. As shown, the website 30 may provide a unique login page for each insured 22 to access his/her own personal insurance information via a secure username and/or password. In addition, the website 30 may provide general information including, but not necessarily limited to orientation information, a forms library, frequently asked questions (FAQs), a “Contact Us” link for contacting the benefit communication administrator 16, a link for contacting the carrier(s) 20, and an “About Us” link for information regarding the benefit communication administrator 16. As understood by the skilled artisan, a website page 30 may include any type of information and links as desired. Once an insured 22 logs into his/her personalized insurance information page, one or more of the following types of information may be provided in a searchable format as understood by the skilled artisan: (1) the group plan information, (2) supplemental plan(s) information, (3) a directory of network providers 26, (4) a calculation application for determining the total dollar amount to be covered by insurance and the total dollar amount to be covered by the insured 22 for a particular service or services as performed by one or more healthcare service providers. An exemplary website 30 may also provide information regarding health insurance exchanges 23 applicable to the insured 22.

In particular, an insured's 22 personalized insurance information page may be designed to allow easy access to all insurance benefit information including instructional information on how to maximize benefit coverage over a wide array of healthcare and time of service scenarios via the calculation application-including the maximized application of a primary insurance policy and/or one or more supplemental insurance policies at the time of service from one or more network providers 26 and/or one or more non-network providers 28. The term network provider or “in-network provider” 26 herein refers to healthcare service providers that are contracted with insurance companies or carriers to provide services at a predetermined rate. The term non-network provider 28 refers to all other non-participating providers. Typically, network providers 26 provide services at lower cost than non-network providers 28.

Suitably, each insurance information page is operationally configured for use by the insured 22 and/or the healthcare service provider at the time of service. In one implementation, an insured's information page may include a calculating application or program or other means for calculating a maximum dollar amount for a particular service to be covered by an insured's 22 healthcare insurance, e.g., a primary insurance policy. In a scenario wherein the primary insurance policy does not cover the entire service fee, a calculating application or program may be operationally configured to determine if the outstanding dollar amount is covered by one or more supplemental insurance policies for the insured 22. Thus, the present system and method provide for assisting insureds 22 with minimizing the total dollar amount of out-of-pocket expenses or the copay amount that may otherwise be paid by the insured 22 at the time of service resulting in the insured 22 having to be reimbursed for any overpayments if and when such overpayment is noticed by the carrier(s) 20.

In one mode of operation, the benefit communication administrator 16 may devise an algorithm operationally configured to calculate insurance coverage scenarios for each individual insured 22, or in the alternative, the benefit communication administrator 16 may use a more standard algorithm based on common primary insurance carrier and supplemental insurance carriers for a group of insureds 22. It is further contemplated that the benefit communication administrator 16 may interact with multiple carriers 20 to assist in the negotiation between carriers concerning the coordination of benefits and the portion of healthcare costs to be shared by each carrier 20 as used for calculating insurance coverage scenarios. It is also contemplated that any calculation technique implemented further account for any lifetime maximum dollar amount provided by one or more insurance policies.

Returning to FIG. 1, a benefit communication administrator 16 may provide information via a website page 30 pertaining to health insurance exchanges 23. For example, a benefit communication administrator 16 may (1) provide information regarding qualified health plans, (2) provide information regarding the application process for premium tax credits and cost-sharing subsidies, (3) provide educational information regarding health insurance exchanges, (4) provide an access portal to one or more health insurance exchanges and/or hotlines, (5) provide information regarding health insurance exchange board meetings, (6) provide a means for determining consumer eligibility for tax credits or cost-savings and (7) provide various disclosure standards and qualified health plan display requirements. A benefit communication administrator 16 may also organize regulatory information received from one or more government regulatory bodies 24 into a user friendly format accessible via a website page or “website” 30. For example, an “updates” link may be included wherein a user may review the latest regulatory information regarding new laws/rules/regulations, changes in existing laws/rules/regulations, and proposed legislation (both State and Federal legislation as this application relates to system 10 usage in the United States). The website 30 may also include compliance information such as timelines and/or deadlines, monetary fines and/or fees information, and a FAQs section regarding various laws/rules/regulations. The website 30 may also include links to various governmental agencies and the like, e.g., the United States Food and Drug Administration (FDA) website. Likewise, the website 30 may include information concerning professional organizations and links thereto concerning various healthcare service providers. For example, the website 30 may include a link to the American Medical Association (AMA) website. The information discussed in this paragraph is a valuable tool to not only the insured 22 but also to the employer 18 or employer's HR Department. For example, a HR Department for a large company is often overwhelmed trying to explain insurance benefit information to the insured 22 employees and/or their dependents, whom are often novices regarding insurance benefit details only pondering such subject matter if and when the insured 22 is faced with a healthcare issue. Thus, the HR Department may direct the insured 22 to the website 30 to review policy information, FAQs, and written and/or video tutorials provided by the benefit communication administrator 16. Too, the system 10 may serve the employer 18 or its HR Department as the primary source for regulatory updates and compliance related information as it pertains to the employer 18 and/or insureds 22.

Information received and/or accumulated from the employer 18, carriers 20, and healthcare service providers 26, 28 may be arranged on the website 30 as desired. Suitably, basic information is readily available on each insured's 22 personal insurance information page. Basic information may include, but is not necessarily limited to a photo of the insured 22, the insured's social security number, date of birth, home address, telephone number(s), the insured's credit card information, list of emergency contacts, employer 18 human resources contact information, listings of primary care physicians and other healthcare service providers used by the insured 22, a listing of services and prescriptions offered, a listing of the primary and supplemental insurance carriers 20, a listing of known physical conditions such as high blood pressure, heart ailments, diabetes, allergies, etc., blood type information, known allergies and a listing of medications currently being used or used in the past-all of which may be updated as necessary by the insured 22 or the benefit communication administrator 16 as provided by the employer 18, carrier 20, insured 22, and healthcare service provider 26, 28. Each carrier 18 may also provide the benefit communication administrator 16 with its own plan booklet (traditionally provided to each insured 22), whereby the benefit communication administrator 16 may make the booklet available via the website 30. The system 10 may also be operationally configured so that the benefit communication administrator 16 may make the information contained within the booklet available on the website 30 in a more user friendly format as desired.

In one mode of operation, where an insured 22 is making a preplanned visit to a healthcare service provider, the insured 22 may access his/her personalized insurance information page to review orientation related information or other information to make a baseline assessment as to the anticipated primary and supplemental insurance coverage to pay for the anticipated healthcare service(s) to be provided. As an example, an insured 22 may be making a scheduled annual checkup to his/her dermatologist, which involves a set service fee and possible copay amount.

In another mode of operation, an insured 22 may make an emergency type visit to a healthcare service provider without having reviewed his/her personalized insurance information page, and possibly without having his/her proof of insurance on hand. Under this scenario, at the time of service the insured 22 may direct the healthcare service provider (or an office assistant) to the insured's personalized insurance information page via an internet ready or internet capable computer, e.g., the healthcare service provider's computer. Once accessed, the healthcare service provider may determine or otherwise calculate the primary and supplemental insurance to be applied to the service fee, as well as any dollar amount to be paid by the insured 22. Thus, in an emergency situation including when an insured 22 is without photo identification and/or insurance card information and/or cash/credit, the internet accessible insurance information page is effective to prove identity, insurance coverage, as well as provide a means to make payment via the credit card information listed on the information page.

It is contemplated that insureds 22 may not remember their personalized insurance information page or their username and/or password, thus in another mode of operation insureds 22 may be provided with an internet ready device 32 from his/her employer 18 or the benefit communication administrator 16 for accessing their personalized insurance information page. In another embodiment, insureds 22 may provide their own internet ready device 32. Herein, an internet ready device 32 such as a portable electronic device may include, but is not necessarily limited to a cellular telephone, laptop computer, tablet computer and smart phone or personal digital assistant (PDA) as understood by persons of ordinary skill in the art.

In an embodiment wherein an insured 22 owns a smart phone 32, the benefit communication administrator 16 may provide the insured 22 with a downloadable application for easy access to his/her personalized insurance information page at the time of service. For example, in an emergency situation wherein an insured 22 visits a healthcare service provider, the insured 22 may apply an application program (or “App” as understood by persons of ordinary skill in the art) stored on either the database computer operationally configured to access the insured's 22 personalized insurance information page. The insured 22 and/or the healthcare service provider may then review the information page to determine and calculate the primary and supplemental insurance to be applied to the service fee according to the App, as well as any dollar amount to be paid by the insured 22.

In another embodiment, the App may provide encoded data to be decoded by the healthcare service provider at the time of service via a barcode reader containing decoder circuitry. For example, the data display of the smart phone 32 may provide encoded data in one or more forms including, but not necessarily limited to (1) a one dimensional barcode such as Code 39, Code 93, Code 128, UPC, EAN, JAN, Interleaved 2 of 5, Code 11, Codabar, MSI Plessey, RSS Family, etc.; (2) a two-dimensional barcode such as PDF 417, QR Code, Data Matrix, Maxicode, MicroPDF417, Micro QR Code, Codablock, Composite, etc.; and (3) a postal code. In addition, the encoded data may be provided by an RFID chip readable using a RFID reader. Other encoded data technologies may be provided in the future for implementation at such time.

In one embodiment the insured 22 may open the App displaying a two-dimensional barcode. The healthcare service provider may scan the barcode using a barcode reader in communication with the internet allowing the healthcare service provided access to the insured's 22 personalized insurance information page via a computer or like device. In addition to, or in the alternative, once the barcode is scanned a predesigned set of information concerning the insured 22 may be electronically communicated to the healthcare service provider in readable form and/or downloadable form. Likewise, the App may include a calculation program or the like to assist the healthcare service provider in determining or otherwise calculating the primary and supplemental insurance to be applied to the service fee, as well as any dollar amount to be paid by the insured 22.

The invention will be better understood with reference to the following non-limiting examples, which are illustrative only and not intended to limit the present invention to a particular embodiment.

### Example 1

In a first non-limiting example incorporating the system of FIG. 1, an insured 22 suffering physically from an accident is rushed to a hospital for immediate surgery. The insured 22 has on her possession a smart phone 32 including an App provided by a benefit communication administrator 16. Prior to surgery, the insured 22 opens the App allowing hospital administration to scan the barcode provided by the App allowing the hospital access to the insured's 22 personalized insurance information page. The insured 22 includes a layered insurance policy as follows:
I. $3,500.00 expanded first dollar coverage
   With zero ($0.00) deductible, full amount of $3,500.00 may be utilized
   Covers emergency room treatment
   Diagnostic services in or out of healthcare service provider's office
   Outpatient surgery
   Benefits may be assigned to healthcare service provider
II. $4000.00 Expanded Accidental Injury coverage starts after $50.00 copay
   Applies to actual charges not a schedule of care
   Twenty-four (24) hour ON or OFF the job coverage
   No network requirements
   Up to $10,000.00 air or ground ambulance coverage
   Hospital Income up to $300.00 per day for up to thirty (30) days
   Benefits may be assigned or reimbursed to the insured 22
III. Major medical paid 100% up to lifetime limit (Plan with maximum out of pocket of $7,500.00 in network)
   Requires hospital stay of fifteen (15) hours or more when integrated with the above listed components
   Above components may satisfy any out of network patient requirements
   Benefits are assignable.
      The hospital administration applies fees against the insured's 22 policy as described above and as described via tutorial information located on the insured's personalized insurance information page.

### Example 2

In a second non-limiting example, the benefit communication administrator 16 receives policy information for an insured 22 from a carrier 20. The benefit communication administrator 16 adds the policy information to the database 12 for internet 14 access via the insured's 22 personalized insurance information page. The benefit communication administrator 16 also adds tutorial information to the personalized insurance information page based on the insured's 22 policy information.

The policy information is described as follows:
Deductible is raised to $5,000.00 total out of pocket
Component A: $500.00 deductible; 20% of $5000.00 coinsurance
Component B: Major medical with no limit having $5000.00 deductible; no coinsurance
Result: Total out of pocket including deductible is $1,500.00

### Example 3

In a third non-limiting example, the benefit communication administrator 16 receives policy information for an insured 22 from a carrier 20. The benefit communication administrator 16 adds the policy information to the database 12 for internet 14 access via the insured's 22 personalized insurance information page. The benefit communication administrator 16 also adds tutorial information to the personalized insurance information page based on the insured's 22 policy information.

The policy information is described as follows:
Component A: Outpatient—Accident or Sickness
   Optional amounts from $500.00 to $5000.00 no deductible or coinsurance.
   $5,000.00 coverage (first dollar); 50/50 to $10,000.00
Component B: Accident Injury 24 hour:
   Outpatient amounts and coverages including actual charge medical treatment, hospital income, and ambulance.
   Unlimited Major Medical:
   Optional deductible, no coinsurance
   $10,000.00 100% deductible: Zero (0.00) dollars thereafter major medical unlimited plan including zero (0) out of pocket hospital stay
Component C: Accidental Injury
   Choice of $2,000.00 or $4,000.00 medical
   $5.00 or $10,000.00 coverage for ambulance service
   $150.00 or $300.00 per day hospital income
   $50,000.00 or $100,000.00 accidental death
Result: First dollar coverage $5000.00; maximum outpatient cost of $2,500.00

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. A method for providing an insured's health insurance policy information to a user comprising:
compiling an insured's health insurance policy information to computer hardware coupled to computer readable memory featuring an internet-accessible database program;
accessing the data base program via an internet ready electronic device at a desired time and location to obtain the insured's policy information on the database program to attain information therefrom.

2. The method of claim 1 wherein the data base program is accessible in one or more languages.

3. The method of claim 1 wherein the data base program includes instructional material for guiding a user of the data base program in understanding the insured's policy information in view of the services to be rendered and any service fee payable.

4. The method of claim 1 wherein the internet ready electronic device is operationally configured to provide encoded data concerning health insurance policy information decodable by a healthcare service provider.

5. The method of claim 1 wherein the data base program includes a calculating application for calculating a maximum dollar amount to be covered by an insured's health insurance for services to be rendered.

6. A method of maximizing healthcare insurance policy coverage for healthcare related services of an insured at the time of service, the healthcare insurance policy including two or more carriers, the method comprising:
a purchaser purchasing healthcare insurance for an individual insured including a primary health insurance policy from a first carrier and at least one gap health insurance policy from a second carrier, said insurance policies including a network of healthcare service providers;
the purchaser providing the insured's health insurance policy information to a third party for compiling the policy information to computer hardware coupled to computer readable memory featuring an internet-accessible data base program, the data base program being operationally configured to provide insurance related searchable information concerning one or more insureds;
providing one or more insureds with access to the third party's internet-accessible data base program via an internet ready electronic device operationally configured to access information on the data base program;
at the time healthcare related services are to be rendered to an insured including services to be performed by at least one network healthcare service provider and at least one non-network healthcare service provider, accessing the data base program via the internet ready electronic device to locate the insured's policy information in the data base program including primary health insurance policy information and gap health insurance policy information;
using a calculation application accessible via the internet ready electronic device to determine the maximum dollar amount to be paid for the healthcare services under the primary health insurance policy and the maximum dollar amount to be paid under the gap health insurance policy; and
applying the total healthcare policy coverage dollar amounts to the service fee minus any applicable copay amounts calculated.

7. The method of claim 6 wherein the internet ready electronic device includes a mobile internet ready device selected from the group consisting of a cellular telephone, laptop computer, tablet computer, smart phone and personal digital assistants (PDA).

8. The method of claim 7 wherein the internet ready electronic device includes a barcode for accessing an insured's information by one or more healthcare service providers.

9. The method of claim 6 wherein the insured's health insurance information is provided in one or more languages.

10. The method of claim 6 wherein the insured is provided access to the third party's internet-accessible data base program via an internet address using security protected information for accessing the data base program.

11. A system for assisting an insured with obviating out-of-pocket expenses at the time one or more services are to be rendered by a healthcare provider comprising:
computer hardware coupled to computer readable memory featuring an internet-accessible data base program, the data base program being operationally configured to store and process health insurance policy information accessible by one or more Human Resources departments, benefit plan administrators, healthcare practitioners, insurance carriers, healthcare providers, employers, insureds, dependents, and combinations thereof; and
one or more internet ready electronic devices operationally configured to communicate with the internet-accessible data base program;
wherein the data base program includes program code operationally configured to determine the fee payable for the services being rendered under the insured's insurance policy according to one or more of the service fee, an insured's policy information in the data base program including primary health insurance policy information and gap health insurance policy information and the insured's copay requirements.

12. The system of claim 11 wherein the one or more internet ready electronic devices include a two-dimensional code for accessing information on the data base program.
